(19) United States
(12) Patent Application Publication
(10) Pub. No.: US 2008/0028057 A1
(43) Pub. Date: Jan. 31, 2008

(54) System and method to facilitate design and operation of event-driven, embedded solutions

(75) Inventors: Johnathan M. Reason, Port Chester, NJ (US); Han Chen, White Plains, NY (US); ChangWoo Jung, Seongnam (KR); Andrew Kyu Hyun Kim, Paramus, NJ (US); SooYeon Kim, Seoul (KR); Paul Bao-Luo Chou, Montvale, NJ (US); Danny Chan-Yong Wong, Allendale, NJ (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/493,877

(22) Filed: Jul. 26, 2006

(51) Int. Cl. G06F 15/173

(52) U.S. Cl. 709/223

(57) ABSTRACT

An event-driven computer system for simultaneous management and deployment of software onto an application platform comprises one or more computing solutions, the system comprising: a processor for executing computer code and processing information; a memory for storing the computer code and information, the computer code comprising software tools. The software tools comprise: a behavior model editor for constructing a system model that represents the behavior of the application platform; the behavior model editor comprises behavior components, each behavior component representing an aspect of the application platform. The software tools further comprise: a topology model editor for constructing a visual topology model. This topology model editor comprises: a top level of nodes and lower level nodes, and represents a logical topology of the application platform, where each top-level node in the topology model represents at least one computing solution. In addition, the software tools comprise: a mapping algorithm for transforming one or more deployment units into execution units and for mapping one or more execution units to at least one computing solution; and a deployment protocol for distributing the one or more execution units over a network to at least one computing solution.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention generally relates to a method and system for the design and operation of event-driven, embedded solutions; and more particularly, to a method and system for visual, distributed deployment and management of software for visually programmed event-driven, embedded systems.

### BACKGROUND OF THE INVENTION

Event-driven, embedded solutions are composed from many disparate components (e.g., embedded computing platforms, sensors, actuators, software device adapters, software controllers, and other software applications) and driven by “real world” events coming from various sensor modalities (e.g., motion, temperature, light, vibration, weight.). Thus, event-driven, embedded solutions are the composition of hardware and software components, where the hardware often interacts with the real world and the software supervises the operation of the hardware and processes the data and events produced by the hardware.

Event-driven, embedded systems are systems comprising event-driven, embedded solutions. Such systems are becoming prevalent in our society. For example, a point-of-sale (POS) self-checkout application in supermarkets is an event-driven, embedded system, where each self-checkout lane represents an event-driven, embedded solution. Each checkout lane solution is typically composed of software running on an embedded microprocessor-based computing platform and a number of sensors/actuators, including a bar code scanner, a cash/credit card reader, a speaker, a weight scale, and a touch pad.

A consumer interacts with the bar code scanner to scan the cost of each item, with the touch pad to select a payment method, and then with one of the payment sensors to render payment for the merchandise. The embedded software computes the total cost of the items scanned, alerts the consumer of any problems (e.g., unrecognized item), alerts the consumer when to make payment, and then verifies that the consumer's payment is valid.

While conceptually simple, realizing such an application can be a very complex process that relies on an interdependent relationship between all relevant partners in the system, which includes device vendors, system integrators, system developers, and the customer's information technology (IT) staff.

System integrators must integrate the hardware and software components into the apparatus, system developers must write application code for customer-specific requirements, system developers (and possibly IT staff) must test and validate the system, and IT staff must deploy the system into the IT infrastructure and manage the system as part of the IT infrastructure.

Given the layers of experts employed throughout the process, the complexity in realizing such an event-driven, embedded system is apparent. At each stage of this process, current methods typically involve the building of custom (and often proprietary) application, middleware, and/or device adapter software. This fully custom approach often leads to one-off systems that are not flexible enough to accommodate changing requirements, such as supporting a new use case without re-designing the application software. Furthermore, while different systems may use similar apparatus, the current custom approach does not facilitate software reuse.

In heterogeneous event-driven, embedded systems, where the solutions have different architectural structure, the IT staff's responsibilities are particularly daunting. This is so because no scalable, systematic method exists for simultaneous deployment and management of all the event-driven, embedded solutions within the system. For example, consider a warehouse-sized supermarket (or department store), where all the checkout lanes are self-checkout lanes. Such a system may contain several dozen self-checkout lanes, each potentially composed from different hardware and software components.

The conventional approach to deploying and managing the software components of each self-checkout lane solution is to deploy and manage each solution one at a time. This approach is cumbersome and time consuming because it does not scale well to a system composed from a large number of disparate solutions. Furthermore, the conventional approach does not lend itself to treating the composition of all the checkout lane solutions as a system. Thus, programming distributed management capabilities across the entire system is not feasible using the conventional approach.

Thus there is a need for a distributed deployment and management technique that effectively addresses the problem of simultaneous and scalable deployment and management of an event-driven, embedded system comprising a plurality of event-driven, embedded solutions.

### SUMMARY OF THE INVENTION

An event-driven computer system for simultaneous management and deployment of software onto an application platform comprises one or more computing solutions, the system comprising: a processor for executing computer code and processing information; a memory for storing the computer code and information, the computer code comprising software tools. The software tools comprise: a behavior model editor for constructing a system model that represents the behavior of the application platform; the behavior model editor comprises behavior components, each behavior component representing an aspect of the application platform. The software tools further comprise: a topology model editor for constructing a visual topology model. This topology model editor comprises: a top level of nodes and lower level nodes, and represents a logical topology of the application platform, where each top-level node in the topology model represents at least one computing solution. In addition, the software tools comprise: a mapping algorithm for transforming one or more deployment units into execution units and for mapping one or more execution units to at least one computing solution; and a deployment protocol for distributing the one or more execution units over a network to at least one computing solution.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a block diagram illustrating an embodiment of an event-driven, embedded system.

FIG. 2 is a block diagram of a system of software tools 200 used to enable an embodiment of the present invention.

FIG. 3 is a second exemplary block diagram of a system of software tools 300 used to enable another embodiment of the present invention.

FIG. 4 is a flowchart of a method 400 for practicing another embodiment of the present invention.

### DETAILED DESCRIPTION

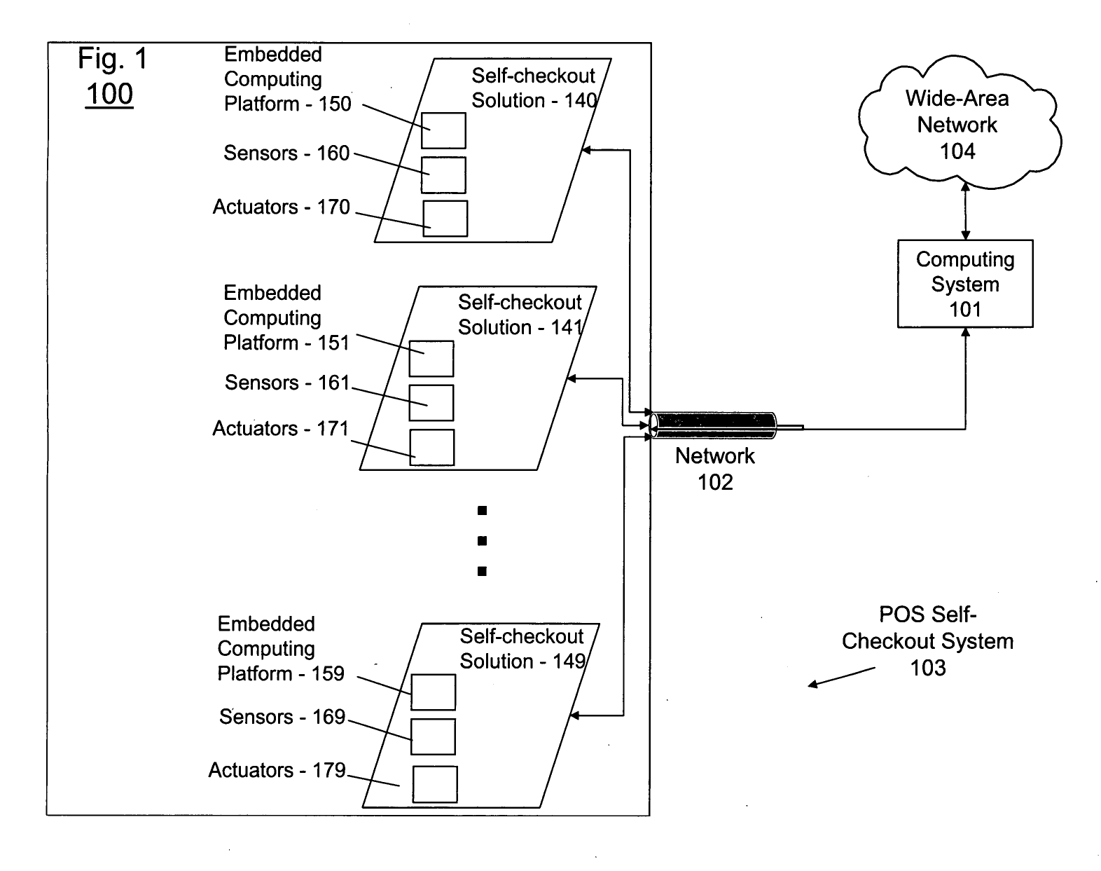

Referring to FIG. 1 we describe an event-driven, embedded system 100. System 100 illustrates an embodiment of the invention for POS (point-of-sale) self-checkout in a supermarket, where many self-checkout solutions (terminals) may be arrayed next to one another. Other embodiments are also possible; for example, a warehouse smart shelf system where many smart shelf solutions may be arrayed next to one another; an electronic toll collection system where many toll lane solutions may be arrayed next to one another; and a retail supply chain logistics system where many loading dock solutions may be arrayed next to one another.

FIG. 1 depicts a multiplicity of self-checkout solutions 140, 141 . . . 149 which by their nature are event-driven. A store customer initiates interaction with a solution 140 by either pressing a key pad or running a store item over a checkout sensor. The system 100 is scalable; therefore, other solutions could be added as needed. Associated with each solution 140-149 is at least one embedded computing platform 150, 151 . . . 159, respectively. In this embodiment, each embedded computing platform also serves as a deployment platform for the system 100. Embedded computing platforms are commercially available and are manufactured by various companies including: Arcom Control Systems, Rockwell Automation, ThingMagic, and Applied Data Systems.

Associated with each self-checkout solution 140-149 are sensors 160, 161 . . . 169, respectively, and actuators 170, 171 . . . 179, respectively. The sensors 160-169 provide a user interface and initiate the event which in this example is a supermarket purchase through a self-checkout terminal. Sensors 160-169 may include a motion detector, a bar code scanner, a radio frequency identification reader, a cash/credit card reader, a weight scale, a touch pad, a microphone, and/or an imaging system. Actuators 170-179 are the devices through which each solution 150-159 responds to user input. The actuators may include a speaker, a display, a conveyor belt, and/or a change dispenser.

For each self-checkout solution, the associated sensors 160-169 and actuators 170-179 interact with the associated embedded computing platform 150-159 through wired or wireless connections, which may include serial, universal serial bus, Firewire, Ethernet, Bluetooth, ZigBee, or other suitable connections. The embedded computing platforms 150-159, also known as deployment platforms, provide the “brains” of each self-checkout solution 140-149 by controlling the input-output (I/O) devices (the sensors and actuators) and by processing the events and data produced by the devices. The embedded computing platforms 150-159 also provide the extension points for deployment and management tools to interact with the POS self-checkout application platform 103. Extension points are used to define new function points for the embedded computing platforms 150-159. Additional plug-ins can plug into these extension points to increase the versatility and scalability of the platforms 150-159.

At least one computing system 101 is used to run the deployment, management, and programming tools and to communicate over a network 102 with the POS self-checkout application platform (or system) 103. The network 102 may be wired or wireless including any of Ethernet, Bluetooth, Wi-Fi, Zigbee, or other networks. The computing system 101 may also interact with other computer systems over a wide-area network 104.

The computing system 101 can be any suitable computing unit comprising basic components such as a processor, system memory, mass storage, and an input/output subsystem connected to the network 102. The system 101 is configured to operate according to an embodiment of the invention. This is accomplished by software tools or by specialized hardware comprising logic for performing the functions of the software tools, such as an Application-Specific Integrated Circuit (ASIC). The network 102 can be a local area or wide area network. We now discuss embodiments where the appropriate configuration is accomplished with software tools.

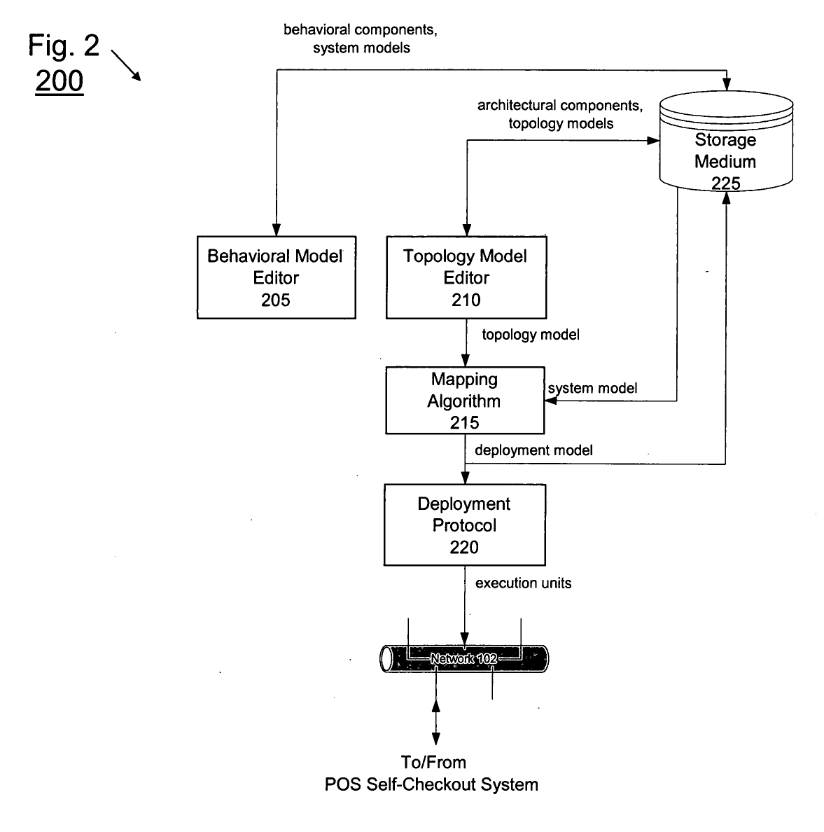

FIG. 2 is a block diagram of a set of software tools 200 stored in computing system 101. The software tools 200 include a behavior model editor 205, a topology model editor 210, a mapping algorithm 215, a deployment protocol 220, and a storage medium 225, each described in detail below.

The behavioral model editor 205 is used to construct a visual system model that represents the behavior of the POS self-checkout application platform 103 of FIG. 1. A visual system model is constructed by interconnecting components that are accessible through a storage medium 225, where each component represents some aspect of the application platform 103 behavior (e.g., device adapters for the associated sensors and actuators of each solution). If the system model requires a new component not available from the storage medium 225, then this component is created using the editor behavioral model editor 205, and then persistently stored in the storage medium 225 for subsequent reuse.

Once all of the system behavior is specified in the system model, the behavior model editor 205 is used to select one or more groups of components in the model and to designate each group as a deployment unit. Referring again to FIG. 1, for the POS self-checkout application platform 103, ten deployment platforms 150-159 may be specified, one for each group of components comprising each self-checkout solution 140-149. The system model, which includes an interconnection of behavioral components and the associated deployment unit structure, is then stored persistently in the storage medium 225 for subsequent reuse.

The topology model editor 210 is used to construct a visual topology model that represents the logical, hierarchical topology of the POS self-checkout application platform 103. A topology model is constructed by interconnecting architectural components that are accessible through the storage medium 225, where each component represents a node in a system architecture.

At the lowest level of the topology hierarchy, the topology model specifies what types of and how many sensors and actuators are connected to each embedded computing platform 150-159. In this embodiment, this is equivalent to specifying the internal topology of each self-checkout solution 140-149.

At the top level in the topology hierarchy, the topology model specifies which and how each self-checkout solution 140-149 is interconnected to compose the POS self-checkout application platform 103. Each node at the top of the topology hierarchy contains at least one deployment platform 150-159 (e.g., an embedded computing platform). Once the topology model has been specified, it is persistently stored in the storage medium 225 for subsequent reuse.

This hierarchical modeling is extensible. For example, a sensor (or actuator) may represent a composition of sensors (or actuators). Therefore, a sensor (or actuator) may also have a topological structure. Similarly, what we have identified as the system in this embodiment may in fact be only a subsystem in some other embodiment and, hence, only a leaf node in the topological structure.

The mapping algorithm 215 transforms a system model into execution units and then it maps execution units to deployment platforms in a topology model to produce a deployment model. Thus, a deployment model represents a binding of specific behavior to each top-level node in a topology model. The structure of a deployment model has three primary parts: a model identifier, one or more execution units, and one or more mappings.

A model identifier is a unique identifier that distinguishes one deployment model from another. It can be any identifier suitable for indexing and searching, such as a universal resource locator (URL).

An execution unit is a deployment unit made suitable for execution on a targeted deployment platform. Thus, the behavioral components that make up each deployment unit are transformed into executable components. This transformation is typically accomplished through compiling the source code of the behavioral components.

A mapping is a binding of each execution unit to a particular deployment platform of each top-level node in the topology model. As a first approximation, the mapping algorithm performs each binding by making the best match between the topological 2-tuple {number of child nodes, type of child nodes} and the behavioral 2-tuple {number of device adapter components, type of device adapter components}, where the best match may be defined by any suitable metric (e.g., the Euclidean distance between tuples).

If the resources (such as memory, processor speed, and communications interfaces) of each top-level topological node are considered, further refinements on the mapping are possible. If no best match is found for a particular deployment unit, then user intervention, through a visual interface, is required to perform manual mapping.

The mapping algorithm 215 has two primary modes of operation: automatic and semi-automatic. In automatic mode, the algorithm 215 assumes its mapping is correct and passes the deployment model on to the deployment protocol 220. Semi-automatic mode prompts a user to override a plurality of the mappings determined by the algorithm. The mapping algorithm 215 presents a user with this manual override feature through a visual interface. The deployment model is also stored persistently in the storage medium 225.

The deployment protocol 220 uses the deployment model to distribute the respective execution units over the network 102 to the appropriate deployment platforms 150-159 within the POS self-checkout system 103. The deployment platforms 150-159 then load the execution units.

While FIG. 2 illustrates a system of software tools 200 of an embodiment of the invention as part of the same computing system 101, this does not preclude other configurations. Each tool can be distributed across different computing systems. In fact, one key advantage of this embodiment is its inherent separation of task domains. For example, the task of constructing a system model is independent of constructing a topology model. Thus, in an alternative embodiment, two or more users working on two or more computer systems can perform these two tasks in parallel instead of sequentially.

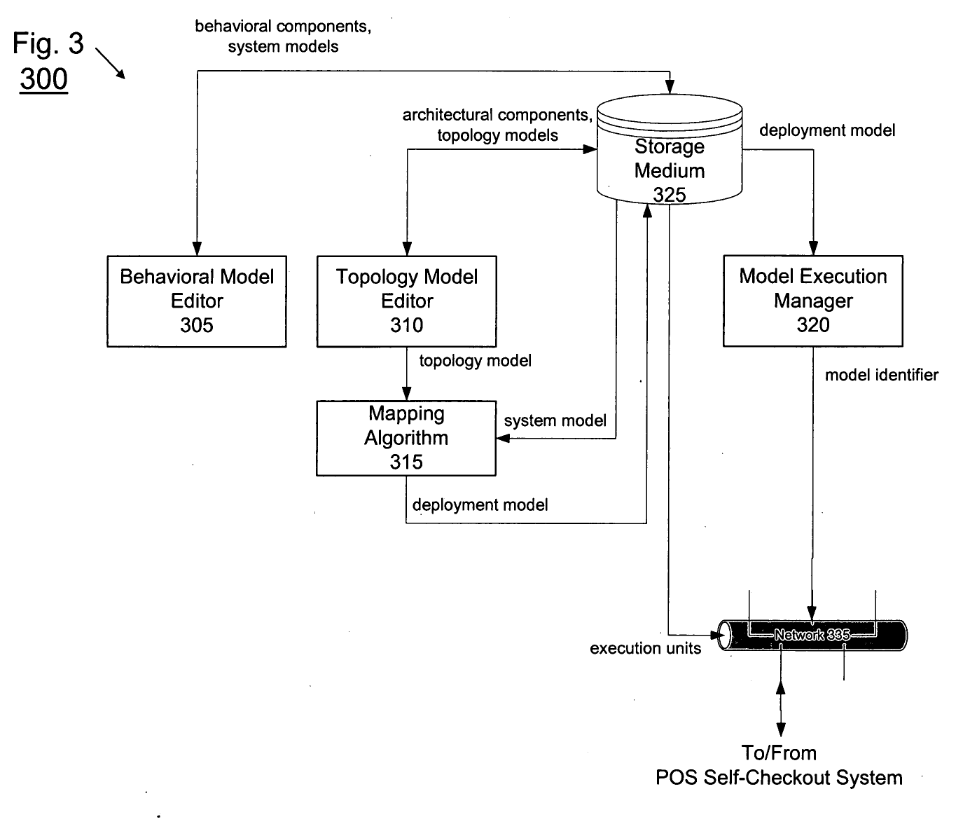

To further illustrate the separation of task domains advantage, FIG. 3 illustrates a second exemplary embodiment of tools. Using this system of tools 300, constructing system, topology, and deployment models is the same as the system of tools described in FIG. 2. However, the deployment process is accomplished via pull semantics instead of push semantics.

The deployment protocol software (not shown) is now distributed between a new software tool, the model execution manager 320, and at least one embedded computing platform 150-159 of the POS self-checkout application platform 103. The model execution manager 320 initiates deployment by transmitting the model identifier over the network 102, to the POS self-checkout application platform 103. The POS self-checkout application platform 103 responds by pulling the execution units, associated with the model identifier, from the storage medium 225 over the network 102. In this embodiment, as in the embodiment referred to in FIG. 2, the behavioral model editor 205, the topology model editor 210, and the mapping algorithm 215 all function in the same manner and store their results in the storage medium 225. The benefit of using the model execution manager 320 tool is that it enables the remote management of the applications.

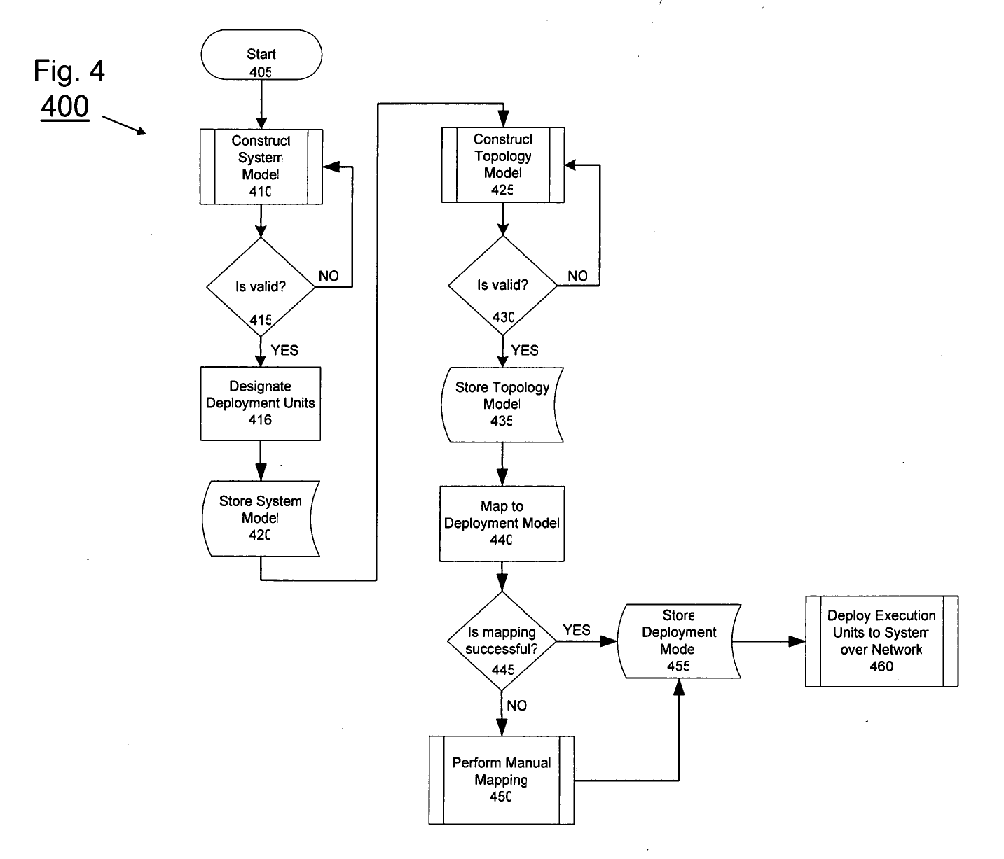

FIG. 4 is a flowchart of a method 400 for practicing an embodiment of the present invention. The method described in FIG. 4 complements the first exemplary system of tools described in FIG. 2. The process flow of the method starts in step 405. Using the behavior model editor 205, a user constructs a visual system model in step 410. The system model is constructed by visually interconnecting behavioral components. The user validates the system model behavior in step 415. This can be accomplished via a method of the user's choice, including simulation, experimentation, or formal analysis.

If the system model is not valid (e.g., a “NO” in step 415), the user redesigns then reconstructs the model. Otherwise, if the system model is valid (e.g., a “YES” in step 415), the user proceeds to the next step, designating the deployment units 416.

The user can designate deployment units using several methods. One method is as follows. Using a mouse or similar input device, the user selects a group of components in the visual system model by drawing a rectangular box around the components. Then by clicking the right mouse button within the model diagram and selecting the appropriate context menu item, the user can designate the components contained in the rectangular region as a deployment unit.

In another exemplary method, the user can select one or more components in the system model diagram one-by-one using the left mouse button and the control key simultaneously. The selected components can then be designated as a deployment unit by using a toolbar button. For one skilled in the art, it should be obvious that other exemplary visual methods of designating deployment units are possible.

The user does not have to assign all components in a system model diagram to a deployment unit. Any component that is not explicitly assigned to a deployment unit is considered an autonomous component. That is, with respect to its deployment, it can be deployed independently of the other components. Once the user has designated the deployment units, then the system model is stored for subsequent use in step 420.

Using the topology model editor 210, a user constructs a visual topology model in step 425. The topology model is constructed by visually interconnecting architectural components. Each architectural component can optionally be annotated with parameters that specify its resources (e.g., memory capacity, processor speed, communication interface) and properties (e.g., network address, symbolic name).

The user validates the topology model architecture in step 430. This can be accomplished via a method of the user's choice, but most often is simply a visual comparison between the logical structure of the model and the physical structure of the system. If a system description file that details the systems properties and resources is available, then the user may optionally import this file to the topology model. Such a file may also serve as a validity check.

If the topology model is not valid (e.g., a “NO” in step 430), the user redesigns then reconstructs the model. Otherwise, if the topology model is valid (e.g., a “YES” in step 430), then the topology model is stored for subsequent use in step 435.

A mapping of a system model and a topology model into a deployment model occurs when the user invokes the mapping algorithm in step 440. In one exemplary method, the user invokes the mapping algorithm by dragging a system model from a workspace view onto the visual topology model using the topology editor. This action invokes the mapping algorithm to transform deployment units into execution units and find the best match between deployment units and autonomous components in the system model to each deployment platform of each top-level node in the topology model.

In automatic mode, the mapping algorithm operates unassisted to generate a deployment model. However, there is one scenario where user assistance may be needed. If the mapping algorithm is unsuccessful in step 445 in finding a match for one or more deployment units or autonomous components, then user intervention is needed to perform manual mapping in step 450.

In semi-automatic mode, the algorithm performs the mapping normally, but after the automatic mapping, the user is prompted to manually override a plurality of mappings. The deployment model is not generated until the user completes the override process. The topology editor may have a toggle button that allows the user to enable or disable automatic mode of the mapping algorithm.

One exemplary method of performing manual mapping is to present the user with a visual palette containing the deployment units of the system model. When the user selects a deployment unit on the palette, the corresponding top-level node it is mapped to in the topology model is highlighted. The user can then override mappings or create new mappings via drag-n-drop of deployment units from the palette to the appropriate top-level node in the topology model. The mapping algorithm then generates the deployment model.

Once the mapping algorithm has generated a deployment model, then the deployment model is stored for subsequent use in step 455.

The user then deploys the execution units of the deployment model over a network in step 460 to the appropriate deployment platforms 150-159 within the POS self-checkout system 103. In one exemplary method, the user performs this action by using a mouse (or other input device) to click the “Deploy” toolbar button on the deployment model view within the topology editor.

In another exemplary method, the user performs this action by using a mouse (or other input device) to open a deployment window from within the topology editor. The deployment window provides the user with a visual interface to select the deployment model, edit the deployments configuration parameters, and then deploy the model.

While the invention has been described in terms of several exemplary embodiments, those skilled in the art will recognize that the invention can be practiced with modification within the spirit and scope of the appended claims. What has been shown and discussed is a highly-simplified depiction of a programmable computer apparatus. Those skilled in the art will appreciate that other low-level components and connections are required in any practical application of a computer apparatus.

Therefore, while there have been described what are presently considered to be preferred embodiments, it will be understood by those skilled in the art that other modifications can be made within the spirit of the invention.

We claim:

1. An event-driven computer system for simultaneous management and deployment of software onto an application platform comprising one or more computing solutions, the system comprising:
a processor for executing computer code and processing information;
a memory for storing the computer code and information, the computer code comprising software tools comprising:
a behavior model editor for constructing a system model that represents the behavior of the application platform; the behavior model editor comprising behavior components, each behavior component representing an aspect of the application platform;
a topology model editor for constructing a visual topology model, comprising a top level of nodes and lower level nodes, and representing a logical topology of the application platform, where each top-level node in the topology model represents at least one computing solution;
a mapping algorithm for transforming one or more deployment units into execution units and for mapping one or more execution units to at least one computing solution; and
a deployment protocol for distributing the one or more execution units over a network to at least one computing solution.

2. The system of claim 1, further comprising a storage medium storing software tools of the system and to store the system model, the topology model, and the behavior components.

3. The system of claim 1, further comprising an execution model manager for initiating deployment of the software tools by transmitting a model identifier to the application platform.

4. The system of claim 1 wherein the system model is constructed by a user visually interconnecting behavioral components in response to presentation of the user interface.

5. The system of claim 1 further comprising an interface for receiving a user designation of deployment units.

6. The system of claim 1 further comprising an interface for receiving a topology model.

7. The system of claim 1 wherein the one or more computing solutions are event-driven systems comprising:
an embedded computing platform for deploying input/output devices, the embedded computing platform comprising:
logic for managing the input/output devices;
sensors for initiating user interaction; and
actuators for responding to a user of the system.

8. The system of claim 1 wherein the mapping algorithm transforms deployment units from a system model into execution units, and then it maps execution units to deployment platforms in a topology model to produce a deployment model.

9. The system of claim 8 wherein the mapping algorithm works in semi-automatic mode wherein a user can override mappings or create new mappings via drag-n-drop of deployment units from a palette to the appropriate top-level node in the topology model.

10. The system of claim 9 wherein the deployment model contains three primary parts:
a model identifier for uniquely identifying the deployment model;
one or more execution units for executing on the deployment platform; and
one or more mappings for binding each execution unit to a particular deployment platform of each top-level node in the topology model.

11. The system of claim 8 wherein the mapping algorithm performs each binding by making a best match between a topological 2-tuple and a behavioral 2-tuple, wherein the best match is defined by any suitable metric.

12. The system of claim 11 wherein the topological 2-tuple indicates number of child nodes and type of child nodes; and the behavioral 2-tuple indicates number of device adapter components and type of device adapter components.

13. The system of claim 7 wherein the embedded computing platform further comprises extension points.

14. The system of claim 6 wherein the topology model is an extensible hierarchical construct.

15. A method for design and operation of event-driven solutions for use in at least one application platform comprising:
interconnecting behavioral components of each event-driven solution and designating deployment units for the components;
receiving a design of a system model comprising interconnected behavioral components;
receiving a designation of deployment units that assigns at least some components to each deployment unit;
enabling construction of a visual topology model and a visual deployment interface;
receiving and storing a topology model;
mapping the system model and the topology model into a deployment model upon user invocation of a mapping algorithm;
receiving and storing a deployment model; and
deploying execution units to the application platform.

16. The method of claim 15 wherein the execution units are deployed over a network.

17. The method of claim 15 wherein the task of constructing a system model is independent of constructing a topology model.

18. The method of claim 15 wherein the mapping algorithm performs each binding by making a best match between a 2-tuple from the topological model (number of child nodes, type of child nodes) and a 2-tuple from the behavioral model (number of device adapter components, type of device adapter components).

19. The method of claim 15 wherein the mapping algorithm works in automatic and semiautomatic mode.

20. The method of claim 15 wherein preceding the interconnecting step the method further comprises the step of presenting a user interface for visually interconnecting behavioral components of each event-driven solution and designating deployment units for the components.

21. The method of claim 15 wherein presenting the step of enabling construction the method comprises the step of presenting a user interface for a topology model editor.

22. A computer readable medium for designing and operating event-driven solutions for use in at least one application platform, comprising program instructions for:
interconnecting behavioral components of each event-driven solution and designating deployment units for the components;
receiving a design of a system model comprising interconnected behavioral components;
receiving a designation of deployment units that assigns at least some components to each deployment unit;
enabling construction of a visual topology model and a visual deployment interface;
receiving and storing a topology model;
mapping the system model and the topology model into a deployment model upon user invocation of a mapping algorithm;
receiving and storing a deployment model; and
deploying execution units to the application platform.
